(19) United States
(12) Patent Application Publication
(10) Pub. No.: US 2003/0137281 A1
(43) Pub. Date: Jul. 24, 2003

(54) Light system for RC vehicles not requiring an extra battery

(76) Inventor: Bruce Binkley, Stevensville, MT (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/313,895

(22) Filed: Dec. 6, 2002

Related U.S. Application Data
(60) Provisional application No. 60/340,684, filed on Dec. 12, 2001.

(51) Int. Cl. H02J 7/00

(52) U.S. Cl. 320/137

(57) ABSTRACT

A light system for RC Vehicles using one or more light assemblies with a low-power consumption, high intensity LED. The light system is powered by the battery used to power the steering and other functions of the RC Vehicle and may be connected to various sockets of the RC receiver used in the RC Vehicle. Arrangements using the light system are shown headlights, taillights, brakelights and steerable search lights.

### CROSS-REFERENCE TO RELATED APPLICATION

This application claims the benefit of U.S. Provisional Patent Application No. 60/340,684, filed Dec. 12, 2001, which is incorporated herein by reference in its entirety.

### BACKGROUND OF THE INVENTION

1. Field of the Invention

This invention relates to a light system for RC Vehicles, and in particular, to such a light system which does not require use of an extra battery.

2. Description of the Related Art

It is very important for all radio control miniature vehicles (RC Vehicles) and especially for those vehicles to be used in competition, to maintain its weight as low as possible. Low weight enables RC Vehicles to perform in a competition by increasing the acceleration, reducing the braking time, as well as extending a run time. Low weight also contributes to preserve the usage of the lifting power of all RC Flying Sources such as Helicopters and Airplanes and in turn to extend the flying time. It is unlikely for RC manufactures as well as for the RC aftermarket industry to develop and try to market an RC Vehicle Light System comprising additional batteries. As of today, batteries are still the heaviest portions of any electronic equipment. Good batteries are also expensive.

### BRIEF SUMMARY OF THE INVENTION

It is an object of the present invention to provide light system for RC Vehicles.

It is an object of the present invention to provide lights system not requiring any additional battery.

It is another object to provide a light system of minimal weight so that it can be installed on all RC Vehicles and especially on vehicles participating in a competition without substantially increasing the weight of said vehicles.

It is another object to provide a fully operational, yet very efficient light system for RC Vehicles that only requires an extremely small electric current.

It is further an object to power said RC Light System directly from an RC Receiver using any socket: marked “B” socket whether is already busy or not as well as any RC channel socket, even if said channel socket is currently engaged to control a servo or any other RC devices.

It is further an object to provide better control over RC Vehicles by utilizing said light system in other to see clearly the direction of said RC Vehicle as well as stopping/braking maneuvers of the next RC Vehicle especially in RC Vehicle competition.

It is further another object to provide a Micro-Servo activated Dimmer-Switch to convert RC Vehicles Taillights into RC Tail/Stoplights.

It is further another object to reveal a way to control a Micro-Servo activated Dimmer Switch, ESC (Electronic Speed Control), as well as power the RC Vehicle Light System from the same socket which is corresponding to a single RC Channel.

It is furthermore another object to provide an RC Vehicle Searchlight.

It is furthermore another object to show a way for said searchlight to illuminate always in the traveling direction of said RC Vehicle (motorcycle headlight effect).

### BRIEF DESCRIPTION OF THE SEVERAL VIEWS OF THE DRAWINGS

FIG. 1 is a cross-sectional side view of a light assembly embodying the present invention.

FIG. 2 is an isometric view of a light system using two of the light assemblies shown in FIG. 1.

FIG. 3 is an isometric view of the light system of FIG. 2 mounted to an RC vehicle chassis bracket.

FIG. 4 is a schematic diagram of the light system of FIG. 2 shown connected to an RC receiver.

FIG. 5 is a schematic diagram of a pair of the light systems of FIG. 2 using a standard RC “Y” harness to connect the RC receiver, with one of the light systems serving as headlights and the other light system serving as taillights for an RC vehicle.

FIG. 6 is an isometric view of an alternative light system using two light assemblies embodying the present invention.

FIG. 7 is a schematic diagram of the light system of FIG. 7 shown connected to an RC receiver and an electronic speed control (ESC).

FIG. 8 is an isometric view of another alternative light system using four light assemblies embodying the present invention.

FIG. 9 is a schematic diagram of the light system of FIG. 8 shown connected to an RC receiver and serving as a searchlight.

### DETAILED DESCRIPTION OF THE INVENTION

It is an object of the present invention to provide a light system for all RC Vehicles, that will not require any additional batteries, therefore will not substantially increase the weight of such vehicles. This is achieved, by having a low current, high output light system (comprising high intensity LED's as a light producing devices), plugged directly into the RC Receiver. Such a Light System is fully functional and as further described is very useful. Each socket on the RC Receiver has 3 pins. Pin 1 is the control pin, it is irrelevant and will be omitted in our description. Pin 2 is a positive pin consisting of anywhere between 4.8 to 6V DC and is corresponding with red wire. Pin 3 is a negative pin of 0V DC and is corresponding with a black wire on a standard RC Servo Wire or RC Wire Harness. The low current Light System, as one comprising High Intensity LED as a light source, is plugged directly in to any socket on the RC Receiver. Even if such socket is already busy, because it's corresponding channel is controlling a Servo or any other RC Device, the “Y” Harness should be plugged to that socket in order to share the power from pin 2 and pin 3 of that socket, between the Light System and said early RC Device. Latest, electrically powered RC Vehicles are using ESC (Electronic Speed Control) to monitor the current flow between the main battery and the drive motor. In these, the power from said main drive battery is also transferred through the ESC to power the RC Receiver and further, to power all RC Devices as servos etc., using pin 2 and pin 3 in a socket corresponding with each channel controlling said devices. As a result, all said latest vehicles with ESC have RC Receiver with socket market “B” (battery) empty but yet being alive with DC Power on pin 2 and pin 3. It is the object of this invention to utilize pin 2 and pin 3 of this socket as well as pin 2 and pin 3 off any channel socket to power the low current high output RC Light System.

Having a fully functional low current high output RC Light System will enable:

1. An RC Vehicle driver to know from a distance, in which direction his as well as the competing RC Vehicles are moving by seeing White, or especially in bright day driving recommended, more accessible to human eye, Blue Headlights or in case of moving in contrary direction the Red Taillights.

2. In situation when a competing RC Vehicle is ahead of said RC Vehicle and is braking, the driver of said RC Vehicle will be warned by means of functional Brakelights on the competing car.

3. Flying an RC Helicopter is often very confusing especially for inexperienced pilots. Usually in a situation when the Helicopter is flying in a direction towards a Pilot, said Pilot is misusing his controls, steering the Helicopter to the right rather then to the left and vice versa. Being able to see at least one Headlight (recommended blue-better visible in a daylight), rather then a red (installed on the tail), said pilot will be reminded of the direction his Helicopter is flying and to use his controls in a manner of a “mirror reflection”. A similar principle applies to an RC Airplane as well as to an RC Boat.

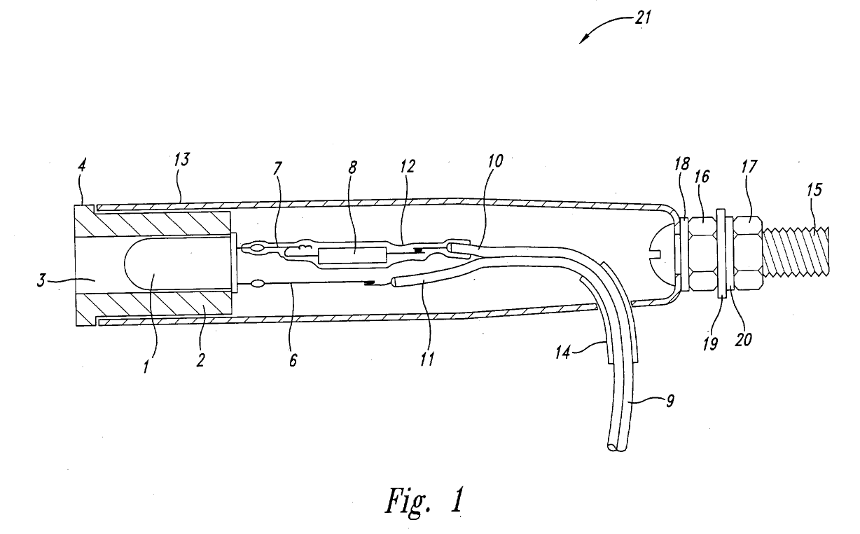

FIG. 1 shows a preferred embodiment of a Light Assembly 21. High Intensity T-1¾ inch (5 mm) LED 1 is pushed into a plastic ring 2 (preferably made of vacuum chromed plated nylon) of an outside diameter approximately 9 mm, with approximately a 4.8 mm in diameter hole 3. The ring 2 has a collar/stopper 4 toward the LED's lens end. LED 1 is then secured to the plastic ring 2 with a drop of Super Glue or other suitable adhesive. The LED's positive pin 7 is trimmed approximately half way, and in case of a White, Blue, Green LED, 100 Ohms, ¼ Watt resistor 8 has one end soldered to the end of the pin. In case of Amber or Red LED, the resistor 8 is to be 200 Ohms, ¼ Watt. A two conductor No. 24-gage wire 9, has a first conductor-red, positive 10 soldered to the other end of resistor 8, and a second conductor-black 11 soldered to the LED's negative pin 6. The resistor 8 and both soldering points are covered with a 3/16-3/32 inch shrinking tube 12.

The plastic ring 2 is then pushed into an opened end of an aluminum housing 13 that is 9 mm in diameter and 52 mm in long. The collar/stopper and the hole 3 of the ring 2, with the LED 1 lens side facing to the outside of the housing 13, is expose on the outside of the housing 13. The two conductors wire 9 comes out of the aluminum housing 13 through a side hole of 3.5 mm in diameter near the closed end of the aluminum housing where the wire 9 exits through the side hole the wire is covered again with 3/16-3/32 inch shrinking tube 14. The shrinking tube 14 provides additional protection against the metal hole cutting the wire as well as acting as a strain relief and providing an aesthetic appearance.

In a center of the closed end of the housing 13 is a hole 3.5 mm in diameter with machine screw 15 of No. 6×32×½ inch size (projecting there through. A head portion of the screw 15 is inside of the housing 13 and the threaded shaft of the screw extends outside of the housing. The screw 15 has two nuts 16 and 17 on the threaded shaft portion. First nut 16 is fastening the screw 15 to the housing 13 utilizing a lock-washer 18 therebetween. Second nut 17, together with a flat-washer 19 and another lock-washer 20, are provided for the purpose of fastening the headlight assembly 21 to an RC Vehicle chassis or RC Vehicle chassis bracket.

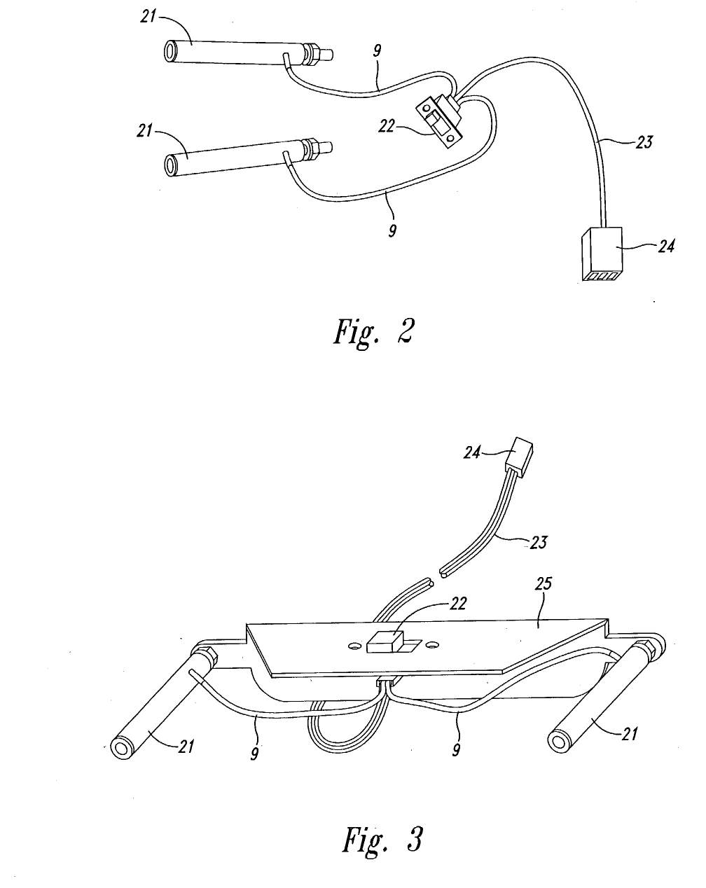

FIG. 2 shows a preferred light system of the present invention using a set of two high intensity Light Assemblies 21 with the construction shown in FIG. 1. The two Light Assemblies 21 are each wired by the two conductor wire 9, of 24 gauge, 3.5 inches in length to an ON OFF slide switch 22 and then to a standard servo wire 23 with a Futaba type female connector 24 on the end of the servo wire.

FIG. 3 shows the light system of FIG. 2 using two of high intensity Light Assemblies 21 attached to a preferred embodiment of an RC Vehicle Chassis Bracket 25.

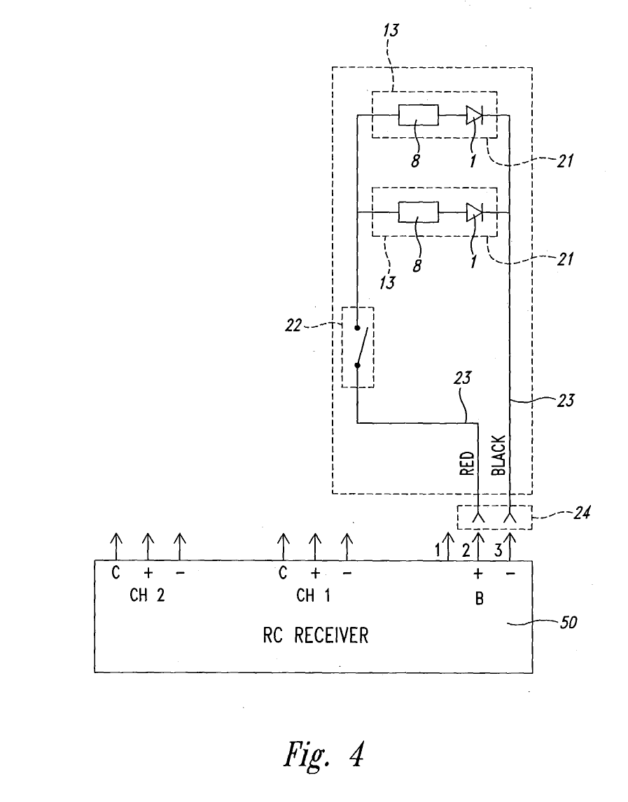

FIG. 4 shows an electrical schematic of the light system of FIG. 2 plugged into the “B” marked socket of an RC Receiver 50. The two Light Assemblies 21 of the light system may serve as RC Vehicles Headlights or Taillights.

FIG. 5 shows a schematic of a pair of light systems as shown in FIG. 2 using a standard RC “Y” Harness 53 to both plug into the “B” marked socket of the RC Receiver 50. The one light system using two Light Assemblies 21 serves as the RC Vehicle headlights and the other light system using two Light Assemblies 21 serves as the RC Vehicle taillights.

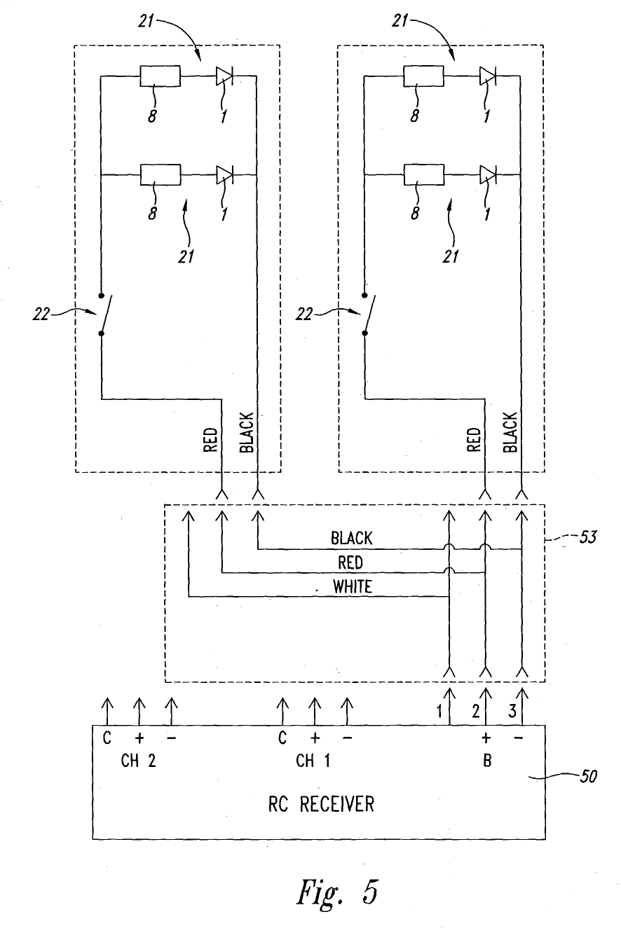

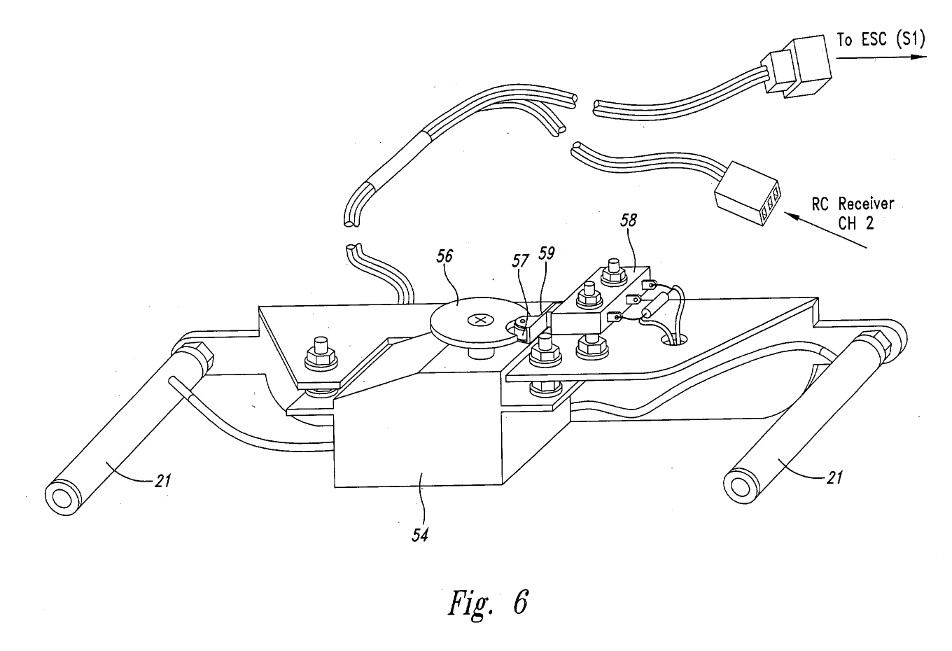

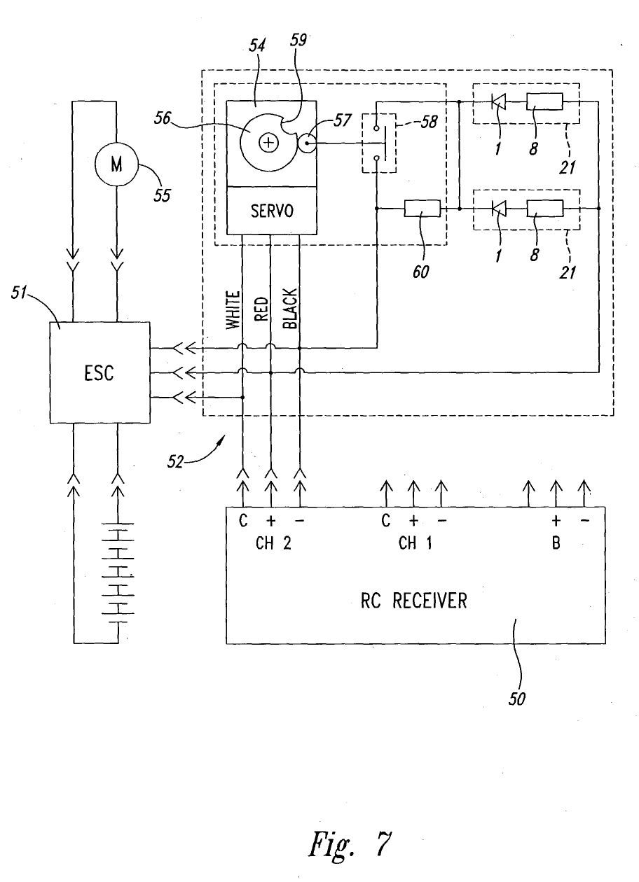

FIGS. 6 and 7 show a more advanced light system for electrically powered vehicles. The light system uses two Light Assemblies 21 serving as taillights, but as will be described, further also functioning as brakelights. As seen in FIG. 7, the light system is connected to an Electronic Speed Control (ESC) 51 of conventional design. The ESC 51 is plugged into a Harness Link 52 on an RC Vehicles Headlight or Taillights System, in parallel with a micro-servo 54, which in turn is plugged into Channel 2 of the RC Receiver 50. When ESC 51 receives a signal from Channel 2 of the RC Receiver 50 to stop a driving motor 55, the micro-servo 54 also receives a signal to turns a servo-wheel 56 in such a position, so that a roller 57 of a micro-switch 58 will fall into a notch 59 on the servo-wheel 56. This action closes the NC (normally closed) terminals on the micro-switch 58 and thereby bypasses the 470 ohms resistor 60. Now, more current flows via resistor 8 and LED 1 of each Light Assembly 21, brightening the red light, converting the Taillight into a Brakelight.

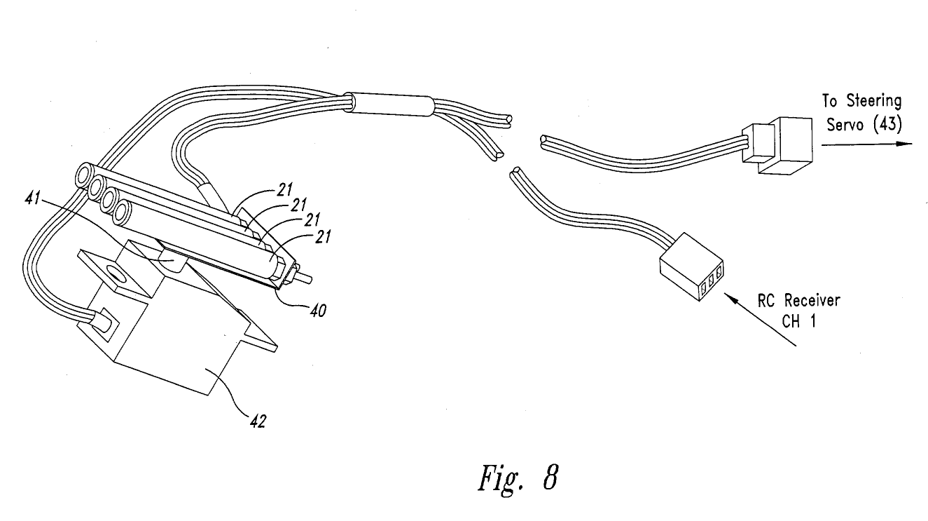

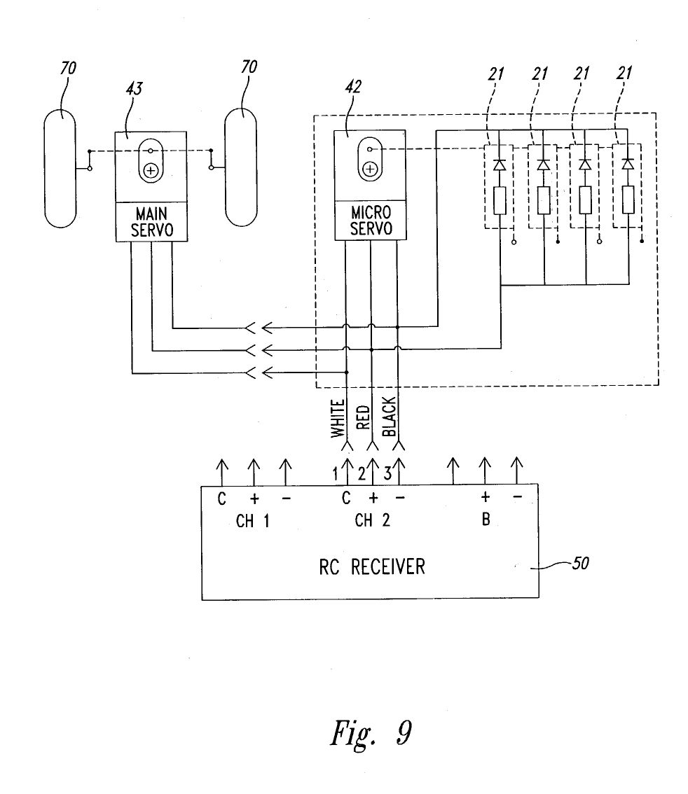

FIGS. 8 and 9 show another embodiment of the present invention, using for purposes of illustration, four Light Assemblies 21 to serve as a searchlight. The four Light Assemblies 21 are attached to a bracket 40, which is mounted onto a servo wheel 41 on the tog of a micro-servo 42. The Light Assemblies 21 are powered directly from the red and black wires of micro-servo 42. The micro-servo 42 (usually an airplane type micro-servo) is controlled by a separate channel as a searchlight only, or as shown on the electrical schematic of FIG. 9, shares a channel with a mainsteering servo 43. In this case, the micro-servo 42 will direct the Lamp Assemblies 21 in the same direction as the main steering servo 43 is directing a pair of front wheels 70 of the RC Vehicle, or alternatively, the rudder of an RC Boat or other steering component of an RC Vehicle.

The above described high intensity Light System can be installed on any RC Vehicles such as cars, trucks, tanks, boats, airplanes and helicopters. It is to be powered directly from the RC Receiver 50. It is compatible working from a “B” marked socket as well as from any other socket on the RC Receiver. There is no need too worry about the power consumption. Whether the RC Receiver is getting its own power from the main-drive battery via the ESC (Electronic Speed Control), as on all new models of electric powered vehicles, or whether it is powered from an auxiliary battery, as all Nitro powered or old fashioned electric powered vehicles. The current that will be drawn by the light system of the present invention from the RC Receiver is only a fraction of the current that is drawn from the same RC Receiver by a servo. RC Vehicles, as miniatures of real vehicles, are in need of being equipped with lights of different colors, as marker lights on airplanes wings (Red & Green), marker lights on trucks (Amber), Tail/Brakelights on cars and trucks (Red), Headlights, Searchlights (White or even Blue). Today's high intensity LED is very efficient in light producing technology, and also provides a coherent light of a variety of different colors. There is no need to filter out the color of the light which causes the light generation to be even more efficient in comparison with any other light source, as for example incandescent, or halogen, krypton light bulbs, which produce white light and require filtering to generate another color.

The light system of the present invention for RC Vehicles does not require an additional battery, but rather operating directly from the RC Receiver.

The light system uses pin 2 (positive) and pin 3 (negative) of a socket, of any channel as well as of socket marked “B” of the RC Receiver, to supply electrical power to the light system.

The light system is very light weight and can be installed on all RC Vehicles, and especially on RC Vehicles participating in a competition without substantially increasing the weight of the vehicles.

The light system uses the electrical power from pin 2 and pin 3 of the “B” marked socket even if that socket is already busy, and may use the socket of any channel to the power light system even if the channel is currently engaged to control a Servo or any other RC device.

The electrical components of the fully operational light system of the present invention for RC Vehicles can be fabricated using only solid state devices, preferably LEDs and as a result is very efficient and works on very small electric current.

The light system are useful to enhance operation of an RC Vehicles to minimize the possibility of being confused while using RC system controls. More specifically, using the light system, a method exists to use white, blue, amber or green headlights and red taillights to indicate the direction in which the RC Vehicle is moving, and/or to use the indication of red brakelights of competing vehicle to avoid a collision.

The light system allows use of high intensity/low power consumption LEDs to serve as a Searchlight controlled by a micro-servo. The micro-servo may be synchronized with the RC Vehicle steering servo, and controlled directly by the steering servo, to provide light in the same direction that the vehicle moves as the vehicle changes direction as it moves about.

From the foregoing it will be appreciated that, although specific embodiments of the invention have been described herein for purposes of illustration, various modifications may be made without deviating from the spirit and scope of the invention. Accordingly, the invention is not limited except as by the appended claims.

I claim:

1. Light System for RC Vehicles not requiring and additional battery, rather operating directly from RC Receiver.

2. The application of pin 2 (positive) and pin 3 (negative) of a socket, of any channel as well as of socket marked “B” of said receiver to supply power to said light system.

3. Light System of very little weight that could be install on all RC Vehicles, and especially on RC Vehicles participating in a competition without substantially increasing the weight of said vehicles.

4. Using the power from pin 2 and pin 3 of “B” marked socket even if said socket is already busy or socket of any channel to power light system even if said channel is currently engaged to control a Servo or any other RC Device.

5. Fully operational light system for RC Vehicles consisting of solid state devices, more specifically LED's in order to be very efficient and work on very small electric current.

6. Utilizing said light system to enhance operation of RC Vehicles to minimize the possibility of being confused while using RC System control's, more specifically:
a. using white, blue, amber or green headlights and red taillights to indicate the direction in which said vehicle is moving
b using the indication of red brakelight of competing vehicle to avoid a collision.

7. High Intensity/low power consumption LED's Searchlight controlled by micro-servo, synchronized with the RC Vehicle steering servo, or control directly by the second, to provide light in to same direction that the said vehicle will move.
